(19) United States
(12) Patent Application Publication
(10) Pub. No.: US 2011/0050665 A1
(43) Pub. Date: Mar. 3, 2011

(54) SOURCE DRIVER AND COMPENSATION METHOD FOR OFFSET VOLTAGE OF OUTPUT BUFFER THEREOF

(75) Inventors: Chien-Hung Tsai, Tainan (TW); Jia-Hui Wang, Tainan (TW); Chin-Tien Chang, Tainan County (TW); Ying-Lieh Chen, Tainan County (TW)

(73) Assignees: HIMAX TECHNOLOGIES LIMITED, Tainan County (TW); NCKU Research & Development Foundation, Tainan (TW)

(21) Appl. No.: 12/549,646

(22) Filed: Aug. 28, 2009

(51) Int. Cl. G06F 3/038

(52) U.S. Cl. 345/211

(57) ABSTRACT

A source driver and a compensation method for an offset voltage of an output buffer are provided. The source driver includes a storage element, an output buffer, a sampling unit and a first switch. The output buffer has a first input terminal coupled to the storage element and a second input terminal coupled to an output terminal thereof. The output buffer enhances an input signal of the first input terminal and thereby outputs an output signal via the output terminal. The sampling unit respectively transmits a pixel signal and the output signal to the first input terminal of the output buffer and the storage element during a first sub-period for storing an offset voltage of the output buffer in the storage element. The first switch transmits the pixel signal to the storage during a second sub-period for compensating the pixel signal with the offset voltage stored in the storage element.

### BACKGROUND OF THE INVENTION

1. Field of Invention

The invention relates to a source driver, and more particular, to a source driver that compensates an offset voltage of an output buffer thereof.

2. Description of Related Art

In recent years, liquid crystal displays (LCDs) have become dominant in the market due to the advantages of low power consumption, zero radiation, and high space utilization. The source driver is an important component in the driving system of the display device, which is used for converting a digital video signal to a driving voltage and providing the driving voltage to a pixel electrode in association with a certain enabled scan line. The driving voltages provided to the pixel electrode are not as good as expected because of the panel loading effect and the process variation. The source driver utilizes the output buffers to enhance the driving abilities of the driving voltages.

Generally, an operational amplifier is utilized to implement the output buffer in the source driver. The operational amplifier is a direct-coupled electronic amplifier with differential inputs, which has high voltage gain. However, an offset voltage exists in the actual operational amplifier because of imperfections in the differential amplifier composed of electronic elements. Due to the high voltage gain of the operational amplifier, the offset voltage results in that an output signal of the operational amplifier will go into saturation if the operational amplifier operates without negative feedback, even when the input terminals of the operational amplifier are wired together. Namely, a swing voltage of the output signal of the operational amplifier is limited. Besides, in a closed loop, the offset voltage is amplified along with the input signal, and the influence of the offset voltage would be more serious to cause incorrect operation of the operational amplifier if the input signal is very small.

In recent year, for enjoyment in the sense of vision, the display panels are fabricated with large size, and the number of gray scale for representation of the image is improved. As a result, the resolution of the source driver must be developed towards a trend of high bit-numbers, and a least significant bit (LSB) in a system specification needs to be more precise. However, due to process variation, the offset voltage of the operational amplifier often exceeds ½ LSB and thereby reduces the precision of the source driver. Therefore, there should be a proper circuit design in the source driver for decreasing the offset voltage of the output buffer.

### SUMMARY OF THE INVENTION

Accordingly, the invention provides a source driver and a method that compensates a pixel signal with the offset voltage of the output buffer in the source driver for reducing the influence of the offset voltage. Therefore, a swing range of an output signal from the source driver can be increased, so does the resolution precision of the source driver.

A source driver adapted to drive a display panel is provided in the invention. The source driver includes a storage element, an output buffer, a sampling unit and a first switch. A first input terminal and a second input terminal of the output buffer are respectively coupled to the storage element and an output terminal of the output buffer. The output buffer enhances an input signal received via the first input terminal thereof and thereby outputs an output signal via the output terminal thereof. During a first sub-period, the sampling unit transmits a pixel signal to the first input terminal of the output buffer and transmits the output signal to the storage element for storing an offset voltage of the output buffer in the storage element. A first terminal of the first switch receives the pixel signal, and a second terminal of the first switch coupled to the storage element. During a second sub-period, the first switch is conducted to transmit the pixel signal to the storage element for compensating the pixel signal with the offset voltage stored in the storage element.

In an embodiment of the foregoing source driver, the source driver further includes an output multiplexer. The output multiplexer is activated according to a switching signal for transmitting the output signal to the display panel. During a conversion period of a frame period, the output multiplexer is inactivated to disconnect the display panel from the output buffer, wherein the conversion period includes the first sub-period and the second sub-period.

In an embodiment of the foregoing source driver, the sampling unit includes a second switch and a third switch. A first terminal of the second switch receives the pixel signal, and a second terminal of the second switch coupled to the first input terminal of the output buffer. A first terminal and a second terminal of the third switch are respectively coupled to the output terminal of the output buffer and the storage element. During the first sub-period, the second switch and the third switch are conducted.

A compensation method for an offset voltage of an output buffer is provided in the invention, wherein the output buffer has a first input terminal coupled to a storage element and a second input terminal coupled to an output terminal thereof. In the compensation method, during a first sub-period, a pixel signal is transmitted to the first input terminal of the output buffer, and an output signal from the output buffer is transmitted to the storage element, such that the storage element stores the offset voltage of the output buffer. Next, during a second sub-period, the pixel signal is transmitted to the storage for compensating the pixel signal with the offset voltage stored in the storage element.

In an embodiment of the foregoing compensation method, an output multiplexer coupled between the output terminal of the output buffer and the display panel is inactivated during a conversion period of a frame period, wherein the conversion period includes the first sub-period and the second sub-period. The output multiplexer is activated according to a switching signal for transmitting the output signal to the display panel.

The invention provides the source driver that stores the offset voltage of the output buffer in the storage element during the first sub-period, and then compensates the pixel signal with the offset voltage stored in the element during the second sub-period for avoiding the output signal from the output buffer from the influence of the offset voltage. Therefore, a swing range of the output signal transmitted to the display panel can be increased. In addition, the compensation operation is performed during the first sub-period and the second sub-period of a conversion period in which the output multiplexer disconnects the display panel from the output buffer. Since the output signal is free from being affected by the panel load, the compensation operation can be more precise.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a circuit diagram of a source driver according to an embodiment of the invention.

FIG. 1B is a timing diagram of a source driver according to the embodiment in FIG. 1A.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

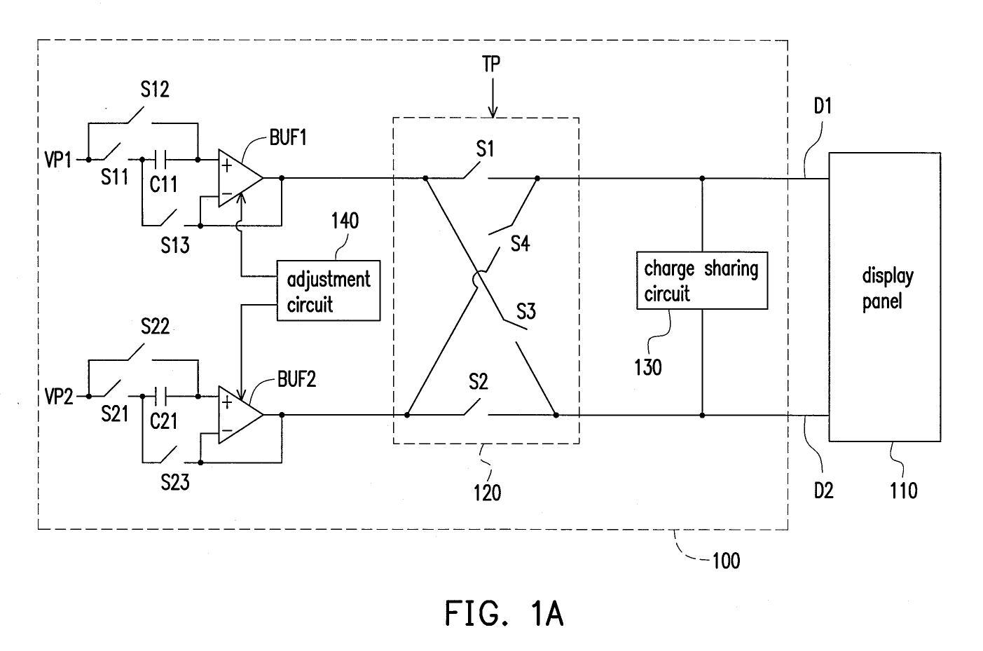

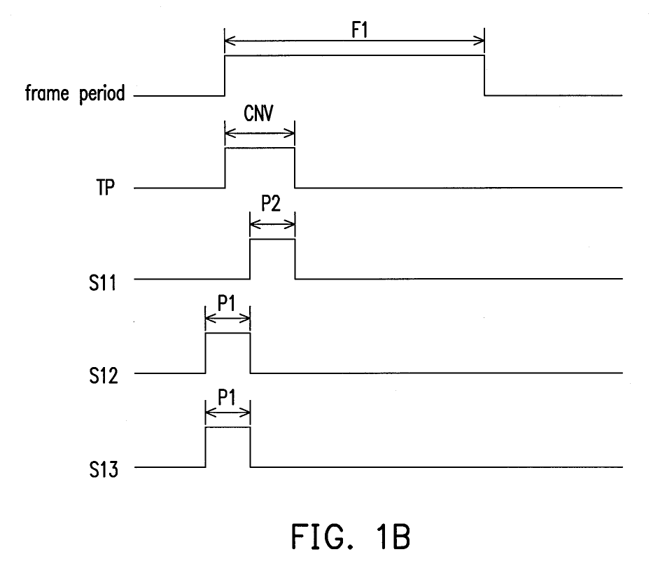

FIG. 1A is a circuit diagram of a source driver according to an embodiment of the invention. FIG. 1B is a timing diagram of a source driver according to the embodiment in FIG. 1A Referring to FIG. 1A, the source driver 100 is adapted to drive a display panel 110, such as a liquid crystal display (LCD) panel or a liquid crystal on silicon (LCOS) display panel. Generally, in order to avoid polarization of liquid crystal, polarity inversion is often performed on the display panel 110 for driving pixels on the display panel 110. Namely, pixel signals with complementary polarities, e.g. positive polarity and negative polarity, are alternatively provided by the source driver 100 to the pixels on the display panel 110 in different frame periods. For saving power consumption, the source driver 110 includes output buffers BUF1 and BUF2 respectively responsible for enhancing the pixel signal VP1 with positive polarity and the pixel signal VP2 with negative polarity, and includes an output multiplexer 120 for respectively transmitting output signals from the output buffers BUF1 and BUF2 to the pixels on data lines D1 and D2 of the display panel 110 or to the pixels on data lines D2 and D1 so as to perform polarity inversion, wherein the output multiplexer 120 includes switches S1 through S4.

In the embodiment of the invention, the output buffers BUF1 and BUF2 are implemented by operational amplifiers, wherein each output buffer has a first input terminal (e.g. a non-inverted terminal denoted as “+”) receiving an input signal, and a second input terminal (e.g. an inverted terminal denoted as “−”) coupled to an output terminal thereof. As known, due to process variation and characteristics of electronic elements, it can not avoid that the actual output buffers BUF1 and BUF2 have offset voltages different from each other. A swing range of the output signal from each output buffer is limited due to the offset voltage, such that the limited output signal can not drive the liquid crystal corresponding to the pixel of the display panel 110 to display fine gray scales of an image. Therefore, the embodiment of the invention teaches a circuit design and a method for compensating the offset voltage of the output buffer.

Taking the output buffer BUF1 as an example, the source driver 100 further includes a storage element C11, a switch S11, and a sampling unit for compensating the offset voltage of the output buffer BUF1, wherein the sampling unit includes switches S12 and S13. A first terminal of the switch S11 receives the pixel signal VP1, and a second terminal of the switch S11 is coupled to a first terminal of the storage element C11. A first terminal of the switch S12 receives the pixel signal VP1 and a second terminal of the switch S12 is coupled to the first input terminal of the output buffer BUF1 and a second terminal of the storage element C11. A first terminal and a second terminal of the switch S13 are respectively coupled to the first terminal of the storage element C11 and the second input terminal of the output buffer BUF1.

As known, the source driver 100 drives the pixels on the display panel 110 to display the image frame by frame. Referring to FIG. 1B, when displaying the image in a frame period F1, the source driver 100 utilizes digital-to-analog converters (not shown in FIG. 1A) to convert the gray scales of the images into driving voltages, e.g. the pixel signals VP1 and VP2. During a conversion period CNV of the frame period F1, in which the gray scales are converted, the unstable driving voltages should be avoided transmitting to the display panel 110. Therefore, during the conversion period CNV, the output multiplexer 120 controlled by the switching signal TP is inactivated for disconnecting the display panel 110 from the output buffers BUF1 and BUF2, wherein the conversion period CNV may starts in the beginning of the frame period.

The conversion period CNV includes a first sub-period P1 for sampling the offset voltage of the output buffer BUF1 and storing the offset voltage in the storage element C11, and includes a second sub-period P2 for compensating the pixel signal VP1 with the offset voltage of the output buffer BUF1. During the first sub-period P1, the switch S12 is conducted to transmit the pixel signal VP1 to the first input terminal of the output buffer BUF1, wherein the pixel signal VP1 serves as the input signal of output buffer BUF1. In addition, during the first sub-period P1, the switch S13 is also conducted to transmit the output signal from the output buffer BUF1 to the first terminal of the storage element C11. In the meanwhile, the offset voltage of the output buffer BUF1 is stored in the storage element C11 since the source driver 100 feedbacks the output signal of the output buffer BUF1 to the storage element C11. Namely, a voltage across the storage element C11 is a voltage difference between the output signal and the input signal of the output buffer BUF1, i.e. the offset voltage of the output buffer BUF1.

During the second sub-period P2 following the first sub-period P1, the switch S11 is conducted to transmit the pixel signal VP1 to the first terminal of the storage element C11. Then, the pixel signal VP1 is compensated with the offset voltage stored in the storage element C11 and thereby serves as the input signal of the output buffer BUF1. The compensated pixel signal VP1 can eliminate the offset voltage of the output buffer BUF1, and then the output buffer BUF1 can generate the output signal without the influence of the offset voltage.

For example, during the first sub-period P1, the pixel signal VP1 with 1 volt is transmitted to the first input terminal of the output buffer BUF1 via the conducted switch S12. Since the first input terminal of the output buffer BUF1 is coupled to the second terminal of the storage element C11, the second terminal of the storage element C11 has the voltage same as the pixel signal VP1, i.e. 1 volt. If the offset voltage of the output buffer BUF is +0.1 volt, the output signal of the output buffer BUF1 is 1.1 volt and transmitted to the first terminal of the storage element C11 via the conducted switch S13. In the meanwhile, the voltage across the storage element C11 is 0.1 volt, wherein the first terminal and the second terminal of the storage element C11 can be respectively seen as a positive electrode and a negative electrode.

During the second sub-period P2, the pixel signal VP1 with 1 volt is transmitted to the first input terminal of the output buffer BUF1 via the conducted switch S11. The pixel signal VP1 is compensated with the offset voltage stored in the storage element C11, and the second terminal of the storage element C11 provides the compensated pixel signal VP1 with 0.9 volt to serve as the input signal of the output buffer BUF1. The decrement of the pixel signal VP1 can counterbalance the offset voltage of the output buffer BUF1, so that the output buffer BUF1 can generate the output signal with 1 volt via the output terminal thereof without the influence of the offset voltage.

It is noted that the compensation operation is performed during the first sub-period P1 and the second sub-period P2 of the conversion period CNV, in which the output multiplexer 120 disconnects the display panel 110 from the output buffers BUF1 and BUF2. The output signal of the output buffer BUF1 is free from being affected by the panel load, and the compensation operation can be more precise. Similarly, the source driver 100 further includes a switch S21, a storage element C21 and a sampling unit composed of switches S22 and S23 for compensating the offset voltage of the output buffer BUF2. The compensation operation of the output buffer BUF2 is similar to the compensation operation of the output buffer BUF1, so that the detail is not iterated.

Moreover, in the embodiment of the invention, the source driver 100 further includes a charge sharing circuit 130 and an adjustment circuit 140. The charge sharing circuit 130 can be implemented by a switch element coupled between the data lines D1 and D2. During the conversion period CNV, the charge sharing circuit 130 performs a charge sharing function on the display panel 110. For example, the switch element is conducted to connect the data lines D1 and D2. Since the output signal of each output buffer changes as the input signal thereof, the charge sharing function makes the pixels on the data lines D1 and D2 as for the same scan line share residual charges on the display panel 110 before the output multiplexer 120 is activated for transmitting the output signals of the output buffers BUF1 and BUF2 to the display panel 110, and reduces a voltage swing of each output buffer for saving power consumption when the output multiplexer 130 is activated. The conversion period CNV may be too short to compensate the offset voltage of each output buffer. The adjustment circuit 140 is used for increasing the driving capability of each output buffer during the conversion period by increasing tails current of each output buffer, so as to speed charging/discharging and to increase the slew rate of each output buffer.

In summary, the embodiment provides the source driver and a compensation method that stores the offset voltage of the output buffer in the storage element during the first sub-period, and then compensates the pixel signal with the offset voltage stored in the element during the second sub-period. The compensated pixel signal serving as the input signal of the output buffer can eliminate the offset voltage of the output buffer, and then the output buffer can generate the output signal via the output terminal thereof without the influence of the offset voltage. Therefore, a swing voltage of the output signal transmitted to the display panel can be increased for displaying fine gray scales of the image. In addition, the compensation operation is performed during a conversion period in which the output multiplexer disconnects the display panel from the output buffer. Since the output signal is free from being affected by the panel load, the compensation operation can be more precise.

It will be apparent to those skilled in the art that various modifications and variations can be made to the structure of the invention without departing from the scope or spirit of the invention. In view of the foregoing descriptions, it is intended that the invention covers modifications and variations of this invention if they fall within the scope of the following claims and their equivalents.

What is claimed is:

1. A source driver, adapted to drive a display panel, comprising:
a storage element;
an output buffer, having a first input terminal coupled to the storage element, a second input terminal coupled to an output terminal thereof for enhancing an input signal received via the first input terminal thereof and thereby outputting an output signal via the output terminal thereof;
a sampling unit, transmitting a pixel signal to the first input terminal of the output buffer and transmitting the output signal to the storage element during a first sub-period for storing an offset voltage of the output buffer in the storage element; and
a first switch, having a first terminal receiving the pixel signal and a second terminal coupled to the storage element, wherein the first switch is conducted during a second sub-period for compensating the pixel signal with the offset voltage stored in the storage element.

2. The source driver as claimed in the claim 1, further comprising:
an output multiplexer, activated according a switching signal for transmitting the output signal to the display panel, wherein the output multiplexer is inactivated to disconnect the display panel from the output buffer during a conversion period of a frame period, and the conversion period comprises the first sub-period and the second sub-period.

3. The source driver as claimed in the claim 2, further comprising:
a charge sharing circuit, performing a charge sharing function on a plurality of pixels disposed on the display panel during the conversion period.

4. The source driver as claimed in the claim 2, further comprising:
an adjustment circuit, increasing a driving capability of the output buffer during the conversion period for increasing a slew rate of the output buffer.

5. The source driver as claimed in the claim 4, wherein the adjustment circuit increases the driving capability of the output buffer by increasing a tail current of the output buffer.

6. The source driver as claimed in the claim 1, wherein the sampling unit comprises:
a second switch, having a first terminal receiving the pixel signal and a second terminal coupled to the first input terminal of the output buffer, wherein the second switch is conducted during the first sub-period; and
a third switch, having a first terminal coupled to the output terminal of the output buffer and a second terminal coupled to the storage element, wherein the third switch is conducted during the first sub-period.

7. The source driver as claimed in the claim 1, wherein the second sub-period follows the first sub-period.

8. A compensation method for an offset voltage of an output buffer, adapted to a source driver to drive a display panel, wherein the output buffer has a first input terminal coupled to a storage element, and a second input terminal coupled to an output terminal thereof, comprising:
transmitting a pixel signal to the first input terminal of the output buffer during a first sub-period;
transmitting an output signal from the output buffer to the storage element during the first sub-period, wherein the storage element stores the offset voltage of the output buffer during the first sub-period; and
transmitting the pixel signal to the storage element during a second sub-period for compensating the pixel signal with the offset voltage stored in the storage element during the second sub-period.

9. The compensation method as claimed in the claim 8, further comprising:
inactivating an output multiplexer coupled between the output terminal of the output buffer and the display panel during a conversion period of a frame period, wherein the output multiplexer is activated according to a switching signal for transmitting the output signal to the display panel, and the conversion period comprises the first sub-period and the second sub-period.

10. The compensation method as claimed in the claim 9, further comprising:
performing a charge sharing function on a plurality of pixels disposed on the display panel during the conversion period.

11. The compensation method as claimed in the claim 9, further comprising:
increasing a driving capability of the output buffer during the conversion period for increasing a slew rate of the output buffer.

12. The compensation method as claimed in the claim 9, wherein the driving capability of the output buffer is increased by increasing a tail current of the output buffer.

13. The compensation method as claimed in the claim 8, wherein the second sub-period follows the first sub-period.
